(19) United States
(12) Patent Application Publication
(10) Pub. No.: US 2016/0288147 A1
(43) Pub. Date: Oct. 6, 2016

(54) Fluid Dispenser and Method of Forming Fluid Dispenser

(71) Applicant: S. C. JOHNSON & SON, INC., Racine, WI (US)

(72) Inventors: Gerald R. Hofmann, Racine, WI (US); Matthew T. McDonnell, Bristol, WI (US); Ronald H. Spang, JR., Kenosha, WI (US); Janet M. Kujawa, Milwaukee, WI (US); Roberta A. Wick, Racine, WI (US); Stacey A. Verbeten, Racine, WI (US)

(73) Assignee: S.C. Johnson & Son, Inc., Racine, WI (US)

(21) Appl. No.: 14/777,820

(22) PCT Filed: Mar. 25, 2014
(86) PCT No.: PCT/US14/31714

§ 371 Date: Sep. 17, 2015

Related U.S. Application Data
(60) Provisional application No. 61/804,868, filed on Mar. 25, 2013.

(51) Int. Cl. B05B 11/00; B05B 1/04; B05B 1/14; B05B 15/00

(52) U.S. Cl. CPC B05B 11/3014; B05B 15/005; B05B 1/044; B05B 11/0027; B05B 1/14

(57) ABSTRACT

A fluid delivery system for dispensing fluid can include a dispenser (10), such as a trigger engine-type dispenser, configured to draw fluid up from a container to dispense a foam-like spray. The dispenser (10) can be configured to draw fluid up from a container. A dispenser body can be configured to mount the dispenser to the container. The dispenser can include a nozzle (N) having an orifice (230), and a mesh (M) material can be placed on the nozzle (N) over the orifice (230). The mesh (M) material can be formed of a polymeric material in one example, and in another example, the mesh material can be formed of a stainless steel material. A method of assembling a dispenser configured to draw fluid up from a container is also disclosed, which can include providing a dispenser body configured to mount the dispenser to the container, securing a nozzle having an orifice to the dispenser body, and securing a mesh material to the nozzle.

### CROSS REFERENCE TO RELATED APPLICATIONS

This Application claims priority to U.S. Application No. 61/804,868 filed Mar. 25, 2013, which is incorporated herein by reference in its entirety.

### FIELD

The present disclosure relates generally to fluid dispensing assemblies and, more particularly, to nozzle assemblies capable of producing foam spray patterns.

### BACKGROUND

Fluid dispensers can take on various general forms, e.g., trigger sprayers, finger type pumps, aerosol dispensers, etc. Nozzle assemblies can be coupled to such fluid dispensers to project different fluid dispensing patterns, e.g., stream, spray (divergent or conical), aerated foam, and the like during dispensing.

The design of such fluid dispensers generally depends on the intended application and/or the characteristics of the fluid that is dispensed. For example, a nozzle may be configured to dispense a foam spray where it is desired to cover a larger cleaning surface area. Other applications may require that the fluid be suspended in the air or to provide increased coverage on a surface, and a nozzle assembly to project a divergent spray may be used. However, if the fluid is intended to be applied to a localized region on a surface, e.g., carpet, wood, a painted surface, etc., a nozzle assembly to project a stream may be used. Product can be dispensed from a bottle by means of a fluid dispenser, such as a trigger engine.

### SUMMARY

This Summary provides an introduction to some general concepts relating to this invention in a simplified form that are further described below in the Detailed Description. This Summary is not intended to identify key features or essential features of the invention.

Aspects of the disclosure herein relate to assemblies for providing a foam spray. In one example, a fluid delivery system for dispensing fluid can include a dispenser, such as a trigger-engine-type dispenser, which may be configured to draw fluid up from a container and dispense the fluid through a nozzle. The nozzle may include an orifice, and a mesh material can be placed over the nozzle. The mesh material can help create a foam-like spray when a fluid is dispensed from the dispenser.

Aspects of the disclosure herein also relate to methods of assembling a dispenser configured to draw fluid up from a container to dispense a foam spray. One example method may include providing a dispenser body, securing a nozzle having an orifice to the dispenser body, and securing a mesh material to the nozzle to configure the nozzle to dispense a foam spray.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 shows an example dispenser for delivering a fluid from a container in accordance with an aspect of the disclosure;

FIG. 2 shows a front perspective view of an example dispenser in accordance with an aspect of the disclosure;

FIG. 2A illustrates a front perspective view of an example nozzle;

FIG. 2B1 illustrates a front view of the nozzle of FIG. 2A;

FIG. 2B2 illustrates an enlarged view of FIG. 2B1;

FIG. 2C illustrates a cross sectional view of the nozzle of FIG. 2A;

FIG. 3A shows a side perspective view of an example dispenser in accordance with another aspect of the disclosure;

FIG. 3B shows a front perspective view of the example dispenser of FIG. 3A;

FIG. 3C shows a side view of a portion of the dispenser of FIG. 3A;

FIG. 3D illustrates an exemplary spray pattern that may be dispensed by the dispensers disclosed herein;

FIG. 3E illustrates an exemplary spray pattern that may be dispensed by the dispensers disclosed herein;

FIG. 4A illustrates a perspective view of exemplary nozzle for a dispenser in accordance with an aspect of the disclosure;

FIG. 4B illustrates a perspective view of the exemplary nozzle in 4A in another configuration;

FIG. 5 illustrates a perspective view of exemplary nozzle for a dispenser in accordance with an aspect of the disclosure;

FIG. 6 illustrates a perspective view of another exemplary nozzle for a dispenser in accordance with an aspect of the disclosure;

FIG. 7A illustrates a schematic of another exemplary nozzle in accordance with an aspect of the disclosure; and

FIG. 7B illustrates a schematic of another exemplary nozzle in accordance with an aspect of the disclosure.

FIG. 7C illustrates a schematic of another exemplary nozzle in accordance with an aspect of the disclosure.

FIG. 7D illustrates a schematic of another exemplary nozzle in accordance with an aspect of the disclosure.

### DETAILED DESCRIPTION

In the following description of the various examples and components of this disclosure, reference is made to the accompanying drawings, which form a part hereof, and in which are shown by way of illustration various example structures and environments in which aspects of the invention may be practiced. It is to be understood that other structures and environments may be utilized and that structural and functional modifications may be made from the specifically described structures and methods without departing from the scope of the present invention.

Also, while the terms “front,” “back,” “rear,” “side,” “forward,” “rearward,” and “backward” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of the invention.

FIG. 1 depicts an exemplary dispenser for delivering a fluid from a container that may be used in conjunction with the embodiments discussed herein. However, it is understood that other types of dispensers could be used in conjunction with the examples described herein. The dispenser 10 can have a body or housing 12 that has an attaching mechanism (e.g. a snap-fit, etc.), shown as threads 14, to attach the body 12 of the dispenser 10 to a container (not shown). The body 12 generally includes an inlet portion and an outlet portion.

The dispenser 10 may include a sprayer mechanism or pump 36 held by or formed within the body 12. The sprayer mechanism 36 includes a piston 16 and a cylinder 18 having cylinder head space 20 above the face of the piston 16. A cylindrical chamber 22 is provided that can be in fluid communication with the cylinder head space 20. The dispenser 10 also includes a cylindrical dip tube 24, which acts as an inlet, for transferring fluid to the chamber 22 from the container. A check valve 26, such as a ball check valve, can be provided which allows fluid to flow only into the cylindrical chamber 22 and not back into the cylindrical dip tube 24 from the cylindrical chamber 22.

The dispenser 10 also includes a finger operated trigger 28 for reciprocatingly moving the piston 16 within the cylinder 18, alternatingly increasing and decreasing the cylinder head space 20 to draw liquid into the cylindrical chamber 22 and then to expel liquid from the cylindrical chamber 22. The dispenser 10 can also include a nozzle 38, which has a discharge orifice 30 for outputting the fluid. A cylindrical discharge conduit 32 may provide fluid communication between the cylindrical chamber 22 and the discharge orifice 30 for receiving fluid from the cylindrical chamber 22 and directing fluid to the discharge orifice 30 in the nozzle 38. The cylindrical discharge conduit 32 can have a discharge check valve 34 that permits fluid to move toward the discharge orifice 30 and not back through the cylindrical chamber 22. However, other types of types of dispenser components can be provided. For example, other types of check valves and biasing members are contemplated for use in conjunction with the dispenser 10.

During use, the actuation of the trigger 28 actuates the piston 16 to create a suction force within the cylindrical chamber 22 thereby causing the cylindrical dip tube 24 to draw up fluid from the container past the check valve 26 and into the cylindrical chamber 22. As the trigger 28 continues to be actuated, the piston 16 causes the fluid in the cylindrical chamber 22 to exit into the discharge conduit 32. The fluid flows past the check valve 34 near the nozzle 38. The fluid then flows into the nozzle 38 and then out the discharge orifice 30.

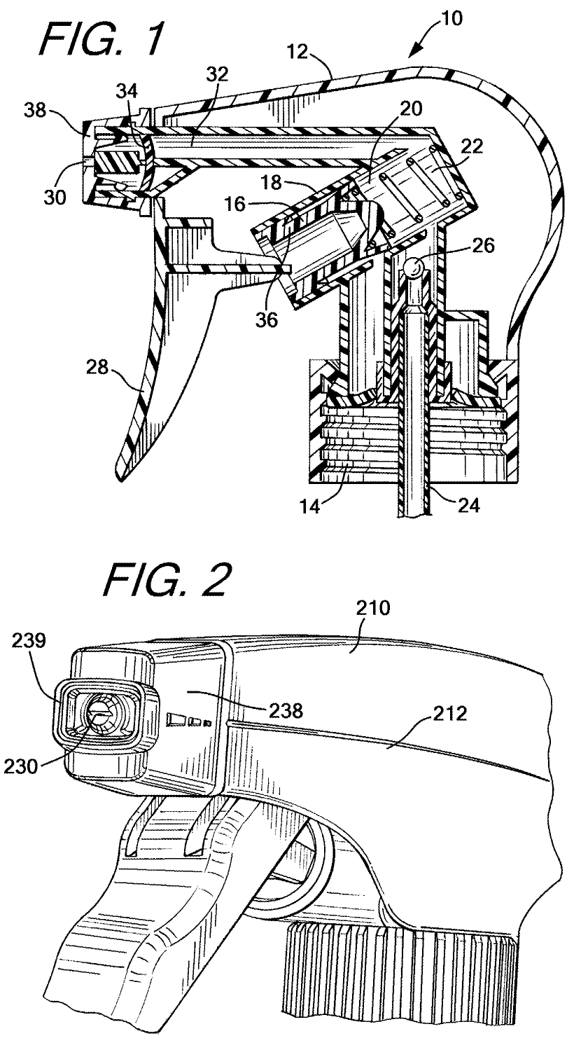

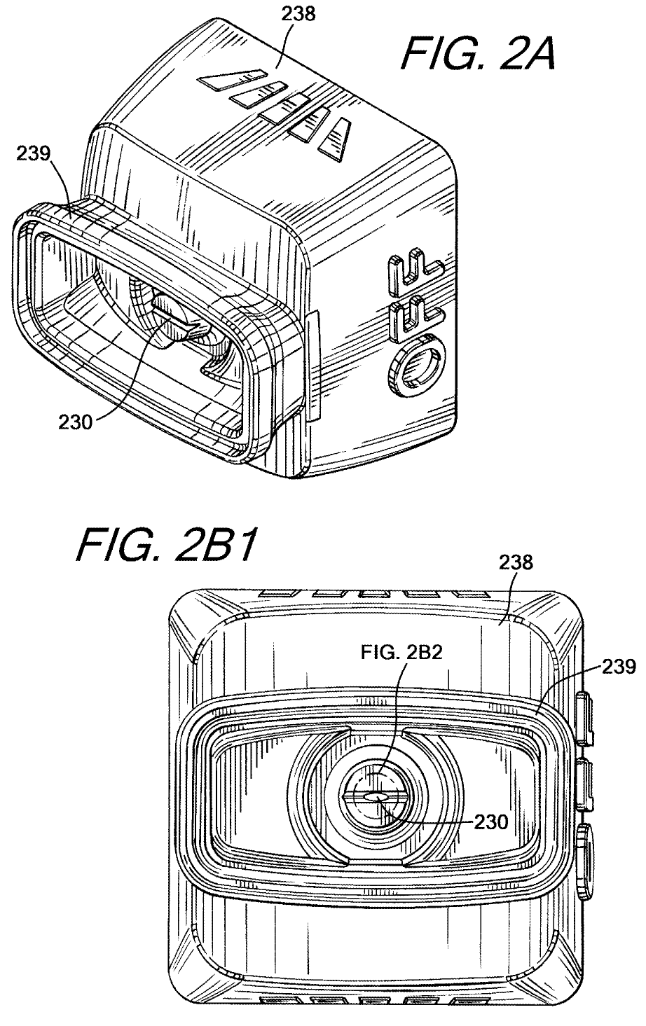

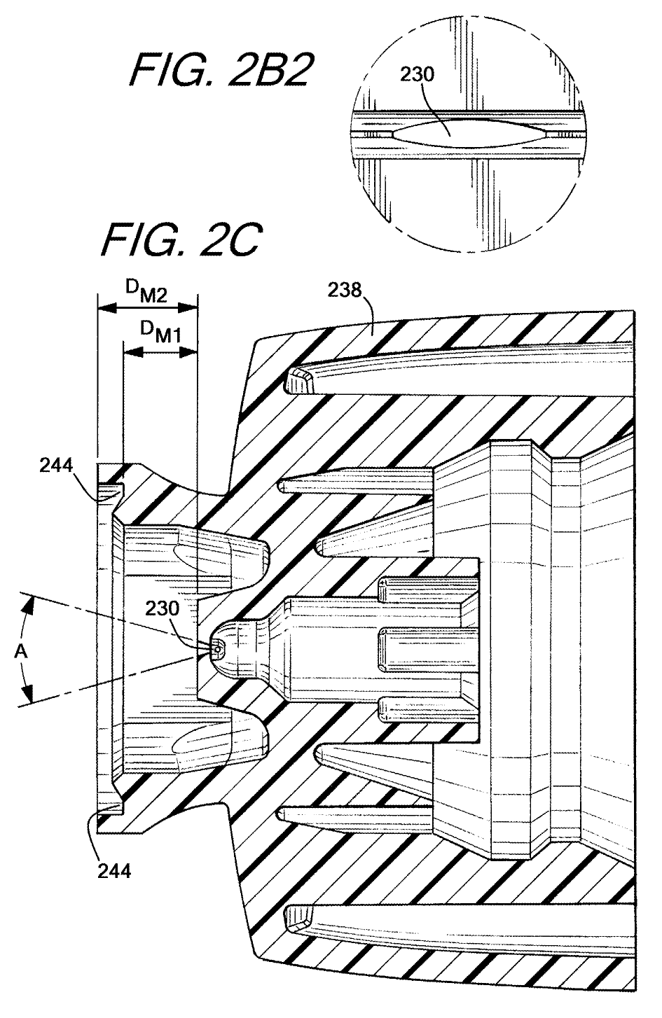

FIG. 2 illustrates an exemplary dispenser 210, which is in the form of a fan-trigger sprayer; FIG. 2A illustrates a perspective view of the nozzle 238; FIG. 2B1 illustrates a front view of the nozzle 238; FIG. 2B2 illustrates the orifice 230, and FIG. 2C illustrates a cross-sectional view of the nozzle 238. As a fan-trigger sprayer, the dispenser 210 is capable of producing an elongated (e.g. fan-like), and possibly enlarged, spray pattern in comparison to a typical circular spray pattern produced by traditional trigger sprayers.

As shown in FIGS. 2, 2A, 2B, 2B1, and 2B2 to at least partially facilitate the production of the fan-like spray pattern, the nozzle 238 can be provided with a discharge orifice 230 in the form of an elongated, oval or oblong shaped slit or opening. However, various other shapes for the discharge orifice are also contemplated, such as circular, rectangular, square, etc., to provide the desired dispensing pattern. Also as shown in FIG. 2C the cross section of the orifice 230 can be formed of a V-shape, where the angle A forming the slit can be 30° to provide the desired dispensing pattern in one example.

The discharge orifice 230 is shown in FIG. 2 as extending in a substantially horizontal (side-to-side) direction relative to the body 212. In such a position, the dispenser 210 would produce a fan-like spray pattern that also extends in a substantially horizontal direction. The nozzle 238 can also be selectively moved to a position in which the discharge orifice 230 extends in a substantially vertical (up-and-down) direction (e.g. by rotating the nozzle 238 approximately 90 degrees. In such a position, the dispenser 210 would produce a fan-like spray pattern that also extends in a substantially vertical direction.

As shown in FIGS. 2, 2A, 2B1, and 2C, to protect or otherwise conceal the discharge orifice 230 and to provide a visual aid for consumers to understand the shape of the spray pattern, the dispenser 210 can include a discharge shroud or discharge enclosure 239 that outwardly extends from the nozzle 238. The discharge enclosure 239 defines an opening that houses the discharge orifice 230 and can extend from one side wall of the nozzle 238 to an opposite side wall of the nozzle 238.

As shown in FIG. 2C, at least the inner surface of the discharge enclosure 239 can be tapered so that the opening defined by the discharge enclosure 239 is smaller at the end attached to the nozzle 238 than at its free end. Such a configuration may enhance the formation of the fan-like spray pattern or may at least be perceived by a user as enhancing the formation of the fan-like spray pattern. The discharge enclosure 239 can be fixedly coupled to the nozzle 238 so that it rotates together with any rotation of the nozzle 238.

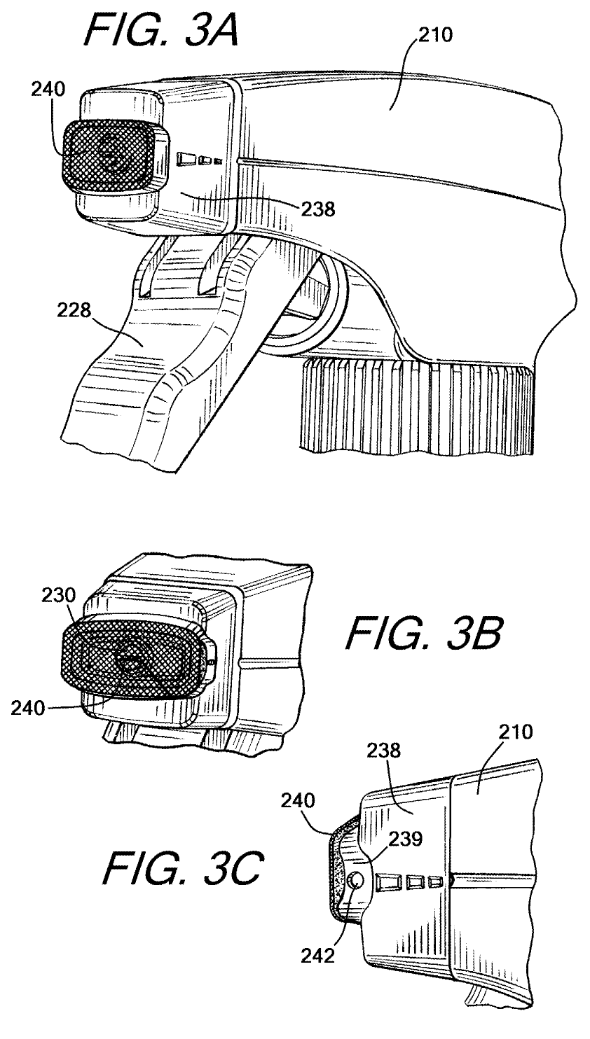

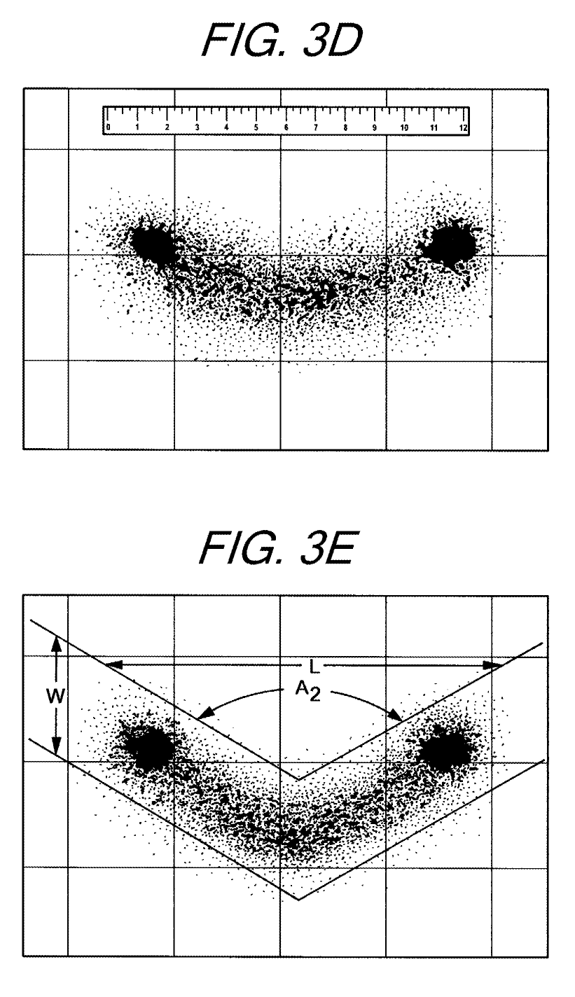

FIGS. 3A-3C illustrate the dispenser 210 configured as a foaming-fan-trigger sprayer. The dispenser 210 can have the same interworking components as the embodiments discussed above in relation to FIGS. 1 and 2-2C, but can be configured as a foaming-fan-trigger sprayer by including a mesh material 240 in front of the discharge opening 230, such as being provided on the front of the nozzle 238. FIG. 3A shows a side perspective view of the dispenser 210, FIG. 3B shows a front perspective view of the dispenser 210, and FIG. 3C shows a side view of a portion of the dispenser 210. FIG. 3D illustrates an exemplary spray pattern that may be dispensed by the dispenser 210.

As shown in FIGS. 3A-3C, the nozzle 238 can be provided with a mesh material 240 which covers the discharge orifice 230. In this way, the discharge enclosure 239 can be formed as a rim-like structure that extends from the nozzle 238 and forms an air pocket between the front of the nozzle 238 and the mesh material 240. Referring back to FIG. 2C, an inner recessed flange or land area 244 that extends about an inner perimeter within the outer edges of the discharge enclosure 239 can be provided for securing the mesh material 240. The mesh material can, thus, be secured to the land area 244 of the nozzle 238, and the front of the mesh material can remain flush a front surface of the discharge enclosure 239. In an alternative example, the mesh material 240 can be placed over the discharge enclosure 239 and can be secured to an outer edge of the discharge enclosure 239.

When placed onto the discharge enclosure 239 of the nozzle 238, the mesh material 240 permits the foaming-fan-trigger sprayer 210 to dispense a foam-like spray. The mesh material 240 can be formed of a polymeric material or a stainless steel material and varies the spray pattern of the product dispensed from the nozzle 238 to a foam-like spray (as shown in FIG. 3D). However, other suitable materials as known in the art are also contemplated for forming the mesh material.

According to an exemplary embodiment, the mesh material 240 may include a series of rectangular, square, circular, oval, oblong, etc. openings, etc. In one example, the openings can be formed rectangular, and each opening can be approximately 145 microns by approximately 150 microns. In another example, the openings can be formed square and each opening can be formed approximately 150 microns.

In addition, as shown in FIG. 3C, the nozzle 238 can be provided with a vent hole 242 on the discharge enclosure 239, which may improve the airflow within the sprayer as well as the foaming of the product as it leaves the nozzle 238 and passes through the mesh material 240. The vent hole 242 can be drilled into the discharge enclosure 239 of the nozzle 238 or integrally formed into the nozzle 238 during the formation of the nozzle 238. In one example, a pair of vent holes can be provided on either side of the discharge enclosure 239 to provide for or enhance the adequate foaming of the spray being dispensed through the mesh material 240.

As shown in FIG. 3D, a spray pattern 250 can be dispensed by the dispenser 210. The dispenser 210 can also dispense the foamed cleaning agent onto a horizontal surface either in any desired orientation, e.g., a downwards orientation or an upside down orientation. As shown in FIG. 3D, the foaming-fan-trigger sprayer 210 can be configured to dispense a foamed cleaning agent onto a vertical surface 252. The foaming-fan-trigger sprayer 210 may provide the user with a substantial amount of cleaning agent coverage, substantial foam cling to the vertical surface 252, and a stable foam consistency.

Additionally, the foam is homogeneous, which may help give the consumer a visual cue for foam surface coverage. In one example, to produce the spray pattern 250 shown in FIG. 3D, the nozzle 238 was positioned to be approximately 8 inches from a tiled wall. At this distance, the resulting spray pattern 250 covered approximately 60 square inches with foam for each pull of the trigger 228. The area covered in foam was approximately 12 inches long by approximately 5 inches high. In other examples, the nozzle 238 can be positioned at 15 inches from the desired surface to be cleaned so as to provide adequate foam coverage.

In another example, as shown in FIG. 3E, the spray pattern can be linear in shape or slightly V-shaped, and the mesh and nozzle configuration can be configured to produce foam with a particular formula. In one example, the V-shape angle A₂ can be 120° to 180° or substantially straight. The pattern can be less than 16 inches long L and less than 2 inches wide W when sprayed from a distance of 15 inches from the surface using 2 full trigger pulls in rapid succession with a pre-primed trigger sprayer. In one example, the spray testing may be completed with water after a statistically significant sampling (e.g. greater than 24 samples).

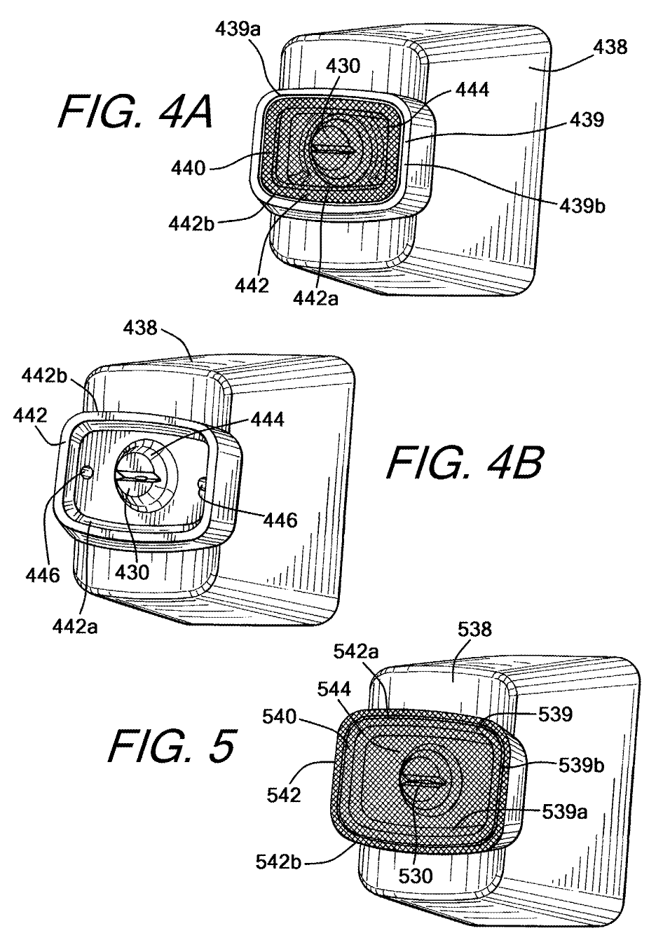

As shown in the examples in FIGS. 4A-4B and 5, a snap-on configuration can be used to secure the mesh to the nozzle. In particular, the mesh materials can be snapped on to the front of the nozzles using an interference-type connection. This can provide the user with the option of removing the mesh when a spray mode is desired. However, other examples are contemplated for securing the mesh to the nozzle.

As shown in FIGS. 4A and 4B, the nozzle 438 can be provided with a discharge enclosure 439 defining an inner perimeter 439a and an outer perimeter 439b. The mesh screen 440 can be provided with a flange 442 having a corresponding shape to the discharge enclosure 439. The flange 442 defines an inner perimeter 442a and an outer perimeter 442b. The inner perimeter 439a of the discharge enclosure 439 can be configured to receive the correspondingly shaped flange 442 about the correspondingly shaped flange 442 outer perimeter 442b. The correspondingly shaped flange 442 can be sized slightly larger than the inner perimeter 439a such that an interference fit is formed between the discharge enclosure 439 and the flange 442 when engaged to aid in securing the mesh material to the nozzle 438.

In addition as shown in FIG. 4B, the nozzle 438 can include two holes 446, which can be configured to receive corresponding projections (not shown) located on the flange 442. The projections on the flange 442 can be configured to be placed into the holes 446 located on the nozzle 438 to assist in securing the flange 442 of the mesh material on the nozzle 438. The projections can be sized slightly larger than the holes 446 to provide for an interference-type fit on the nozzle 438.

FIG. 5 shows another example snap-on type configuration. As shown in FIG. 5, the nozzle 538 can be provided with a discharge enclosure 539 defining an inner perimeter 539a and an outer perimeter 539b. The mesh screen 540 can be provided with a flange 542 having a corresponding shape to the discharge enclosure 539 that defines an inner perimeter 542a and an outer perimeter 542b. The outer perimeter 539b of the discharge enclosure 539 can be configured to receive the correspondingly shaped inner perimeter 542a of the flange 542 to secure the flange 542 to the nozzle 538. The inner perimeter 542a of the correspondingly shaped flange 542 can be sized slightly smaller than the outer perimeter 539b of the discharge enclosure 539 such that an interference or friction fit is formed between the discharge enclosure 539 and the flange 542. A tapering of the outer perimeter 539b of the discharge enclosure 539, along with a corresponding tapering of the inner perimeter of the flange 542, may also assist in or provide for a secure retention force between the discharge enclosure 539 and the flange 542. It is also contemplated that the nozzle 538 could include one or more recesses (not shown) located outside the discharge enclosure 539 to receive projections (not shown) on the flange 542 such that the flange 542 could be received and secured to the nozzle 538.

In the above examples shown in FIGS. 4 and 5, the discharge enclosures 439, 539 and flanges 442, 542 have elongated rectangular-shaped perimeters with rounded sides and edges. However, other shapes are contemplated to form the flanges 442, 542 and flanges 442, 542, such as circular, square, oval, etc.

Additionally, as shown in relation to the examples in FIGS. 4 and 5, the discharge enclosures 439, 539 are provided on the front portions of the nozzles 438, 538 respectively. The discharge enclosures 439, 539 define recesses 444, 544 on the nozzles 438, 538. As shown in relation to FIGS. 4 and 5, the orifices 430, 530 for the nozzles 438, 538 may be formed in the center of the recesses 444, 544. The recesses 444, 544, house the orifices, and the mesh material covers the recesses 444, 544. The recesses 444, 544 provide for adequate air space between the orifices and the mesh screens to provide the desired sprays and foam patterns.

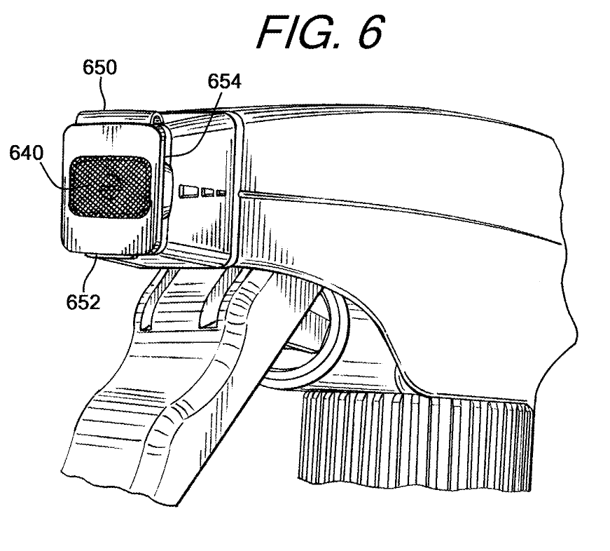

In another example, as shown in FIG. 6, the mesh screen 640 could be secured to the nozzle using a hinge 650 such that the user can close the mesh screen 640 and place the nozzle into a foam dispensing mode, and remove the mesh screen 640 so that the user can place the nozzle into a spray dispensing mode. In this example, the hinge 650 can be a living hinge. The hinge 650 can also be provided with a tab 652, which allows the user to grasp the mesh screen 640 to remove the mesh screen 640 from the nozzle. To secure the mesh screen 640 to the nozzle, in certain examples, the mesh screen 640 can be provided with a rim 654 that is configured to fit over the nozzle via a friction or interference fit, or alternatively the mesh screen can be provided with one or more protections (not shown) that can fit into corresponding recesses provided on the nozzle. In this way, the hinge 650 can provide the user with foam on demand when desired for cleaning purposes.

In addition to the removable mesh examples discussed in relation to FIGS. 4-6, the mesh material can be also be permanently fixed to the end of the nozzle using any known methods in the art. For example, ultra-sonic welding, or heat welding can be used to secure the mesh material to the nozzle. Additionally, the mesh material can be bonded to the nozzle by a compatible, high-bonding strength adhesive (chemical bonding). In one specific example, a Henkel two-part epoxy glue (Loctite® Epoxy Weld™ Bonding Compound—5 min Setting) can be used to secure the mesh material to the nozzle. Alternatively, the mesh material can be dropped into the nozzle such that the mesh resides inside the nozzle.

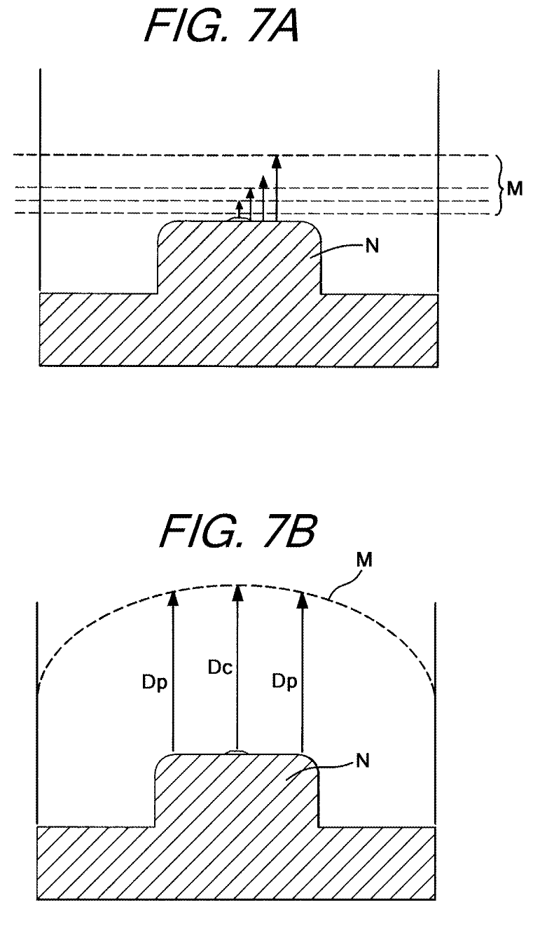

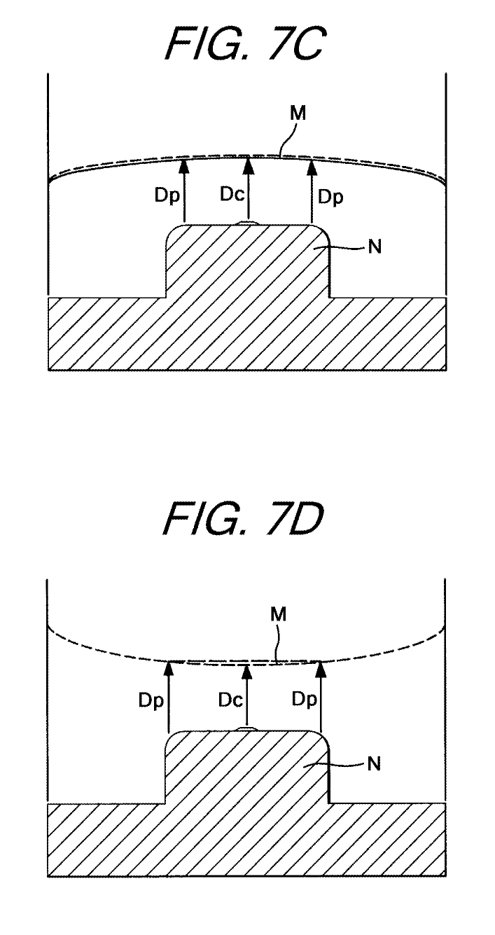

In addition, as shown in FIG. 7A, the mesh material in the above examples can be provided with a flat profile shape. In addition, the distance between the end of the nozzle and the mesh may also affect the quality of the foam dispensed from the dispenser. As shown in FIG. 7A, in certain examples, altering the distance between the mesh M and the nozzle N can optimize the desired amount of foam to be dispensed. For example, providing the mesh closer to the nozzle can provide a circular spray pattern with individual segments having a very fine mist, and increasing the distance between the mesh and nozzle may lead to the cavity formed between the mesh and the nozzle to fill up with fluid causing the spray pattern to be more segmented. Referring back to FIG. 2C, although a mesh is not shown, in one example, the rear of the mesh can be located at a distance (D_{M1}) approximately 2.0 mm from the orifice 230 of the nozzle 238 and the front of the mesh can be located at a distance of (D_{M2}) approximately 2.7 mm from the orifice 230 of the nozzle to produce the desired foaming characteristics.

Forming the mesh material with a curved profile shape may also enhance the foam dispensed from the dispenser. For example, the mesh material M can be provided with an inward curve or an outward curve with respect to the nozzle N, and the mesh material can be formed of a concave, convex, or spherical shape. Providing a curved mesh shape can provide for an increased amount of foam on the surface desired to be cleaned. The mesh M can be provided with a radius of curvature extending from a plane defined by a front surface of the nozzle or a plane extending substantially parallel to a front surface of the nozzle. The radius of curvature can extend from a single point, such as the orifice of the nozzle, to form a constant curvature or several points can define the curvature of the mesh such that the curvature varies across the mesh or such that the shape is formed as elliptical.

In FIG. 7B the mesh material M can be formed in a convex shape and can be configured to curve outwardly from the nozzle. In this example, the nozzle N can be furthest away from the mesh material M at the center point of the nozzle or at the orifice than the edges or a perimeter of the nozzle where Dc is greater than Dp. Moreover, in this example, the radius of curvature can extend from a single point, which in this example can be the orifice of the nozzle. In this example, the radius R can be substantially equal to Dc. As shown in 7B, the mesh material M can be provided with a greater amount of curvature and a constant radius R to provide for the desired foam amount.

As shown in FIG. 7C, the mesh material M can also be formed in a convex shape and can be configured to curve outwardly from the nozzle. However, as shown in FIG. 7C, the curvature can vary across the mesh material M and form a “flatter” shape. In FIG. 7C, the mesh curvature can be defined by two radii extending from two points to define the curvature of the mesh such that the curvature varies across the mesh.

As shown in FIG. 7D, the mesh material M can be formed in a concave shape such that the mesh curves inwardly toward the nozzle N. In this example, the nozzle N can be closest to the mesh material M at the center point of the nozzle or at the orifice than the edges or a perimeter of the nozzle where Dc is less than Dp. Also in FIG. 7D, the mesh curvature can be defined by two radii extending from two separate points to define the curvature of the mesh such that the curvature varies across the mesh or such that the shape is formed as elliptical.

The fluid dispensers disclosed herein are adapted for use with any composition, such as an air freshener, deodorizer, cleaning agent, insect repellant, and any combination of the like, that has intended uses when dispensed as a divergent spray and/or a stream. Such compositions can have a variety of forms including, but not limited to, liquids, foams, gels, etc.

In addition, the examples disclosed herein may have applications for removing soap scum, and hard-water stains (lime-scale). More specifically, the example fan-foaming-trigger sprayers discussed herein can be used to dispense cleaners and cleaning compositions the same as or similar to the cleaners and compositions disclosed in U.S. Pat. Nos. 6,384,010 and 6,812,196, both of which are incorporated herein fully by reference. Additionally, acid or caustic based formulas can be dispensed with the above examples. For example, thickening agents, such as, xantham gums, guar gums, and hydroxy ethyl cellulose based materials may be used in conjunction with the above exemplary embodiments.

In the above examples, the mesh material disperses the spray into the foaming patterns as shown in FIGS. 2D and 3D. Providing the dispensers with the mesh materials as shown and described in relation to the above examples may provide a more stable foam that clings well to the surface desired to be cleaned, and can produce a wide spray pattern and a wide foam coverage area. This results in a stable foam with a long period of cling to the desired cleaning surface to help the cleaning agent to thoroughly clean the desired surface.

Moreover, the above examples provide the ability to apply the foam on both a horizontal surface in any orientation (e.g., both right-side up and upside down) and a vertical surface. Additionally, the above examples provide a homogeneous foam that helps the consumer by giving the consumer a better visual cue for foam-surface coverage to show the extent of the foam coverage. Therefore, less cleaning agent may be required, which may result in a cost savings to the user. Additionally, the coverage area is increased at a faster rate, due to higher foam surface coverage per pull. Thus, the user may be able to apply the foam to one or more surfaces without experiencing hand fatigue and may be utilized to clean quickly because of a quick application of the cleaner. Because of the efficient application of the foam, the trigger sprayer may also be environmentally friendly as compared to aerosols. All of these factors may translate to improved cleaning performance and may also improve the ultimate user experience and user satisfaction with the product.

In one example, a fluid delivery system or a dispenser for dispensing fluid is disclosed. The fluid delivery system can include the dispenser, which can be configured to draw fluid up from a container, and a dispenser body which can be configured to mount the dispenser to the container. The dispenser can also have a nozzle comprising an orifice, and a mesh material covering the nozzle. The mesh material can be formed of a polymeric material in one example, and in another example, the mesh material can be formed of a stainless steel material.

The nozzle can further include a recess, and the recess houses the orifice. The mesh material can cover the recess. A discharge enclosure can extend from the nozzle and can surround the orifice. The mesh material can be connected to the nozzle by one of a friction/interference fit, snap fit, an ultra-sonic weld, a heat weld, or an adhesive. The mesh material can include a flange, and the flange is configured to fit within the discharge enclosure and is configured to secure the mesh material to the nozzle. Additionally, the flange can include projections that are configured to be placed into holes located in the nozzle to assist in securing the flange of the mesh material on the nozzle. Alternatively, the mesh material can include a flange, and the discharge enclosure can be configured to fit within the flange. The flange and discharge enclosure are configured to secure the mesh material to the nozzle. The fluid delivery system dispenser can further include a trigger, and the dispenser can be configured to dispense a foam by actuating the trigger.

In another example, a method of assembling a dispenser configured to draw fluid up from a container to dispense a foam spray can include providing a dispenser body configured to mount the dispenser to the container, securing a nozzle having an orifice to the dispenser body, and securing a mesh material to the nozzle. The method may also include forming the mesh material of one of a polymeric material or a stainless steel material, and forming a recess on the end of the nozzle. The mesh material can cover the recess. The method may also include connecting the mesh material to the nozzle by one of a interference/friction fit snap fit, an ultra-sonic weld, a heat weld, an adhesive or combinations thereof.

In another example, a fluid delivery system for dispensing fluid may include a housing having an inlet portion and an outlet portion, a pump including a trigger lever associated with the housing and being configured to draw fluid up from a container, and a coupling provided at the inlet portion and configured to secure the housing to the container. A nozzle may be provided at the outlet portion and can include an orifice and a mesh material configured to be placed over the nozzle for a foam dispensing mode and can be configured to be removable from the nozzle for a spray dispensing mode.

In one example, the mesh material can be formed of one of a polymeric material or a stainless steel material. The nozzle can further include a recess, and the recess can house the orifice and the mesh material can cover the recess. A rim can extend from the nozzle and surround the orifice to define the recess. The mesh material can include a flange and the flange can be configured to engage the rim to secure the mesh material to the nozzle. The mesh material can be connected to the nozzle by one of a snap fit, a hinge, or combination thereof. The mesh material may also be provided with a curved shape. In one example, the nozzle and the mesh material are configured to provide a foam having a length of greater than 16 inches and a width of greater than 2 inches when dispensed from a distance of 15 inches from a surface.

In another example, a fluid delivery system for dispensing fluid may include a housing having an inlet portion and an outlet portion, a pump including a trigger lever associated with the housing and being configured to draw fluid up from a container, a coupling provided at the inlet portion and configured to secure the housing to the container, and a nozzle provided at the outlet portion comprising an orifice and a curved mesh material covering the nozzle. The curved mesh material together with the nozzle can be configured to provide a foam. The mesh material can be provided with a concave or convex shape. The mesh material can be formed with a constant radius of curvature. The distance from a center of the nozzle to the mesh material can be greater than a distance from a perimeter of the nozzle to the mesh material. The distance from a center of the nozzle to the mesh material can be less than a distance from a perimeter of the nozzle to the mesh material. The mesh material can formed of a polymeric material or a stainless steel material. A rim may extend from the nozzle and can surround the orifice to define a recess, and the recess can house the orifice and the mesh material can cover the recess. The mesh material may include a flange and the flange can be configured engage the rim to secure the mesh material to the nozzle. The mesh material can be connected to the nozzle by one of a snap fit, hinge, an ultra-sonic weld, a heat weld, an adhesive or combination thereof. The nozzle and the mesh material can be configured to provide a foam having a length of greater than 16 inches and a width of greater than 2 inches when dispensed from a distance of 15 inches from a surface.

In another example, a method of assembling a dispenser configured to draw fluid up from a container may include providing a housing having an inlet portion and an outlet portion, providing a pump including a trigger lever associated with the housing and configuring the pump to draw fluid up from a container, providing a coupling at the inlet portion and configured to secure the housing to the container, providing a nozzle at the outlet portion comprising an orifice and placing a mesh material over the orifice of the nozzle, and configuring the nozzle and the mesh material to provide a foam having a length of greater than 16 inches and a width of greater than 2 inches when dispensed from a distance of 15 inches from the surface desired to be cleaned. The method can further include forming the mesh material of one of a polymeric material or a stainless steel material, forming a rim defining a recess on an end of the nozzle and wherein the mesh material covers the recess, connecting the mesh material to the nozzle by one of a snap fit, hinge, an ultra-sonic weld, a heat weld, an adhesive or combination thereof.

The present invention is disclosed above and in the accompanying drawings with reference to a variety of examples. The purpose served by the disclosure, however, is to provide examples of the various features and concepts related to the invention, not to limit the scope of the invention. One skilled in the relevant art will recognize that numerous variations and modifications may be made to the examples described above without departing from the scope of the present invention.

### INDUSTRIAL APPLICABILITY

The disclosure herein provides fluid delivery systems and methods for dispensing fluids. The example fluid delivery systems and methods may, in certain examples, be used to dispense a foam-like spray.

1. A fluid delivery system for dispensing fluid comprising:
a housing having an inlet portion and an outlet portion;
a pump including a trigger lever associated with the housing and being configured to draw fluid up from a container;
a coupling provided at the inlet portion and configured to secure the housing to the container; and
a nozzle provided at the outlet portion comprising an orifice and a mesh material configured to be placed over the nozzle for a foam dispensing mode and configured to be removable from the nozzle for a spray dispensing mode.

2. The fluid delivery system of claim 1 wherein the mesh material is formed of one of a polymeric material or a stainless steel material.

3. The fluid delivery system of claim 1 wherein the nozzle further comprises a recess and wherein the recess houses the orifice and wherein the mesh material covers the recess.

4. The fluid delivery system of claim 3 wherein a rim extends from the nozzle and surrounds the orifice to define the recess.

5. The fluid delivery system of claim 4 wherein the mesh material comprises a flange and wherein the flange is configured to engage the rim to secure the mesh material to the nozzle.

6. The fluid delivery system of claim 1 wherein the mesh material is connected to the nozzle by one of a snap fit, a hinge, or combination thereof.

7. The fluid delivery system of claim 1 wherein the mesh material is provided with a curved shape.

8. The fluid delivery system of claim 1 wherein the nozzle and the mesh material are configured to provide a foam having a length of greater than 16 inches and a width of greater than 2 inches when dispensed from a distance of 15 inches from a surface.

9. A fluid delivery system for dispensing fluid comprising:
a housing having an inlet portion and an outlet portion;
a pump including a trigger lever associated with the housing and being configured to draw fluid up from a container;
a coupling provided at the inlet portion and configured to secure the housing to the container; and
a nozzle provided at the outlet portion comprising an orifice and a curved mesh material covering the nozzle;
wherein the curved mesh material together with the nozzle are configured to provide a foam.

10. The fluid delivery system of claim 9 wherein the mesh material is provided with a concave or convex shape.

11. The fluid delivery system of claim 9 wherein the mesh material is formed with a constant radius of curvature.

12. The fluid delivery system of claim 9 wherein a distance from a center of the nozzle to the mesh material is greater than a distance from a perimeter of the nozzle to the mesh material.

13. The fluid delivery system of claim 9 wherein a distance from a center of the nozzle to the mesh material is less than a distance from a perimeter of the nozzle to the mesh material.

14. The dispenser of claim 9 wherein the mesh material is formed of a polymeric material or a stainless steel material.

15. The dispenser of claim 9 wherein a rim extends from the nozzle and surrounds the orifice to define a recess and wherein the recess houses the orifice and wherein the mesh material covers the recess.

16. The dispenser of claim 15 wherein the mesh material comprises a flange and wherein the flange is configured engage the rim to secure the mesh material to the nozzle.

17. The dispenser of claim 10 wherein the mesh material is connected to the nozzle by one of a snap fit, hinge, an ultra-sonic weld, a heat weld, an adhesive or combination thereof.

18. The dispenser of claim 10 wherein the nozzle and the mesh material are configured to provide a foam having a length of greater than 16 inches and a width of greater than 2 inches when dispensed from a distance of 15 inches from a surface.

19. A method of assembling a dispenser configured to draw fluid up from a container comprising:
providing a housing having an inlet portion and an outlet portion;
providing a pump including a trigger lever associated with the housing and configuring the pump to draw fluid up from a container;
providing a coupling at the inlet portion and configured to secure the housing to the container;
providing a nozzle at the outlet portion comprising an orifice and placing a mesh material over the orifice of the nozzle; and
configuring the nozzle and the mesh material to provide a foam having a length of greater than 16 inches and a width of greater than 2 inches when dispensed from a distance of 15 inches from the surface desired to be cleaned.

20. The method of claim 19 further comprising forming the mesh material of one of a polymeric material or a stainless steel material.

21. The method of claim 19 further comprising forming a rim defining a recess on an end of the nozzle and wherein the mesh material covers the recess.

22. The method of claim 19 further comprising connecting the mesh material to the nozzle by one of a snap fit, hinge, an ultra-sonic weld, a heat weld, an adhesive or combination thereof.

23. A fluid delivery system for dispensing fluid comprising:
a housing having an inlet portion and an outlet portion;
a pump including a trigger lever associated with the housing and being configured to draw fluid up from a container;
a coupling provided at the inlet portion and configured to secure the housing to the container; and
a nozzle provided at the outlet portion comprising an orifice and a mesh material covering the nozzle;
wherein the nozzle and the mesh material are configured to provide a foam having a length of greater than 16 inches and a width of greater than 2 inches when dispensed from a distance of 15 inches from a surface.
